(19) United States
(12) Patent Application Publication
(10) Pub. No.: US 2007/0168199 A1
(43) Pub. Date: Jul. 19, 2007

(54) Method of operating a talent business

(76) Inventor: Richard Urrea, Vancouver (CA)

Correspondence Address: Vermette & Company, Box 40, Granville Square, Suite 230, 200 Granville Street, Vancouver, BC, V6C 1S4, CA

(21) Appl. No.: 10/508,082

(22) PCT Filed: Jan. 13, 2004
(86) PCT No.: PCT/CA04/00003

§ 371 Date: Sep. 16, 2004

(30) Foreign Application Priority Data
Jan. 13, 2003 (CA) 2416071

(51) Int. Cl. G06Q 99/00

(52) U.S. Cl. 705/1

(57) ABSTRACT

A method of selecting and recruiting extras for use in film, television productions and commercials, comprising creating and maintaining a server with a database containing profiles for available extras. The casting director is then provided with a portable computer to connect to and access the database. The casting director downloads selected portions of the database to the portable computer and selects the required extras from the profiles in the selected portion of said database.

### FIELD

The invention is a new and improved method for casting performers in roles, in particular for casting a large number of extras or background performers.

### BACKGROUND

Background performers, referred to as “extras”, are used in many film and television productions to fill out the background of a scene. Typical scenes such as restaurants, city sidewalks and arenas require numerous extras to fully populate the scene so that the film/television scene resembles reality. Depending on the scene, there may be specific requirements for extras, such numbers, age range, appearance (both physical and clothing), as well as the potential need for special skills (e.g. a mime or similar street performer for a sidewalk scene).

The job of selecting the requirements for the extras, as well as ensuring the requirements are fulfilled, generally falls on the casting director for the film/television production. The task of selecting and hiring extras is traditionally very time-consuming and labor-intensive.

First, the casting director needs to contact a number of local talent agencies and provide them with a list of requirements for extras (number of people, age, and appearance). The talent agencies then review their client lists of extras to find those performers that meet the requirements. A package is then prepared by each agency containing profiles of all the extras that meet the casting director's requirements. Each profile typically consists of a black and white photograph and information on the performer as to his/her height, weight, skills, agent information, etc.). Alternatively, the talent agencies may simply book the talent and fax the names of those booked to the casting director.

The packages are usually physically delivered to the casting director who must review the profiles and select the extras necessary for the job. Alternatively, the extras may be selected from various websites. The casting director must then again contact each of the talent agencies and inform them of those extras that they wish to employ. The individual agencies then contact their respective clients and provide them with the date, time, and location for the engagement.

If any of the selected extras are unavailable, the agency must contact the casting director and the profiles must be revisited and additional extras selected. This step may be avoided by providing an extended list of acceptable performers to the agencies initially, but this creates the risk of making a commitment to employ more extras than are needed. Extras are never booked until the casting director indicates his/her preparedness to book them. Rather the casting director gives the agencies a set of selected names and the agencies determine the availability of those on the list. The agent or the casting director through the agent then contacts the available talent on the list and books them.

Obviously, the above system, while it has been in place for many years, is very time-consuming and inefficient. There is a need for an improved system to allow casting directors to quickly and easily select and employ extras meeting a set of desired requirements.

It is an object of this invention to provide an efficient and easy-to-use method for casting directors to select and employ extras.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a flow diagram showing the agent selection process for extras; and

FIG. 2 is a flow diagram showing the casting director's role in selecting extras.

### SUMMARY OF THE INVENTION

The invention is a method of selecting and recruiting extras for use in film, television and commercial productions, comprising creating and maintaining a server with a database containing profiles for available extras. The casting director is then provided with a portable computer to connect to and access the database. For tablet PC's, the website is accessible only after a biometric matching process such as thumbprint recognition is achieved. The casting director downloads selected portions of the database to the portable computer and selects the required extras from the profiles in the selected portion of the database on the portable computer.

According to the invention there is provided method of listing selecting, contacting and hiring extras for film, television and commercial productions, which includes providing a web accessible server with a database containing profiles for extras and a sign-up for extras both for those that are represented by an agent and those that are not. Access to extras that are not represented by an agent is provided to the agent through a server. Information on extras accepted for representation by said agent is recorded on the database. Database information is provided to a casting director and the database is searched for extras fitting a profile specified by the casting director. Availability of each extra fitting the profile is determined and then the server notifies each extra determined to be available.

The method can further allow the casting director to send a list of the required extras to the server and the server, using an automated contact program to contact each extra on the list of required extras, notifies them of potential employment. The server also contacts the agent. The agent can switch the server into direct contact with the talent. The casting director or agent can first review the information before sending it out to the talent.

The method can also allow, after job completion, the casting director to submit a list of extras employed on a production and request that a payroll company hired for the production send the monetary funds for payment to the extras. After approval of the agent, the server then automatically transfers the funds to the extras' bank account using an automated program on the server. The server can also conduct additional transfers for commissions to agents representing the extras and required deductions for taxes and benefits.

### DETAILED DESCRIPTION OF THE INVENTION

The method of selecting extras utilizes a database of performers or extras, which consists of identity and profile information for each performer or extra, along with the name of their talent agency or agent or other representative. The database also includes unrepresented performers which agents are permitted to scout.

The database is designed to allow casting directors to quickly search, contact and employ small or large groups of performers as extras. However, the database and method can be readily expanded or adjusted to include additional performers and personnel required for film and television productions. Sometimes the wardrobe department needs to contact talent. In this case the casting director can prepare the profiles and a temporary password can be provided to the wardrobe person to enable that wardrobe person to contact the talent assigned to that password.

The database system has four designated categories of user: talent (extra or performer), agent, casting director, and administrator. Administrator users may not be included in all databases.

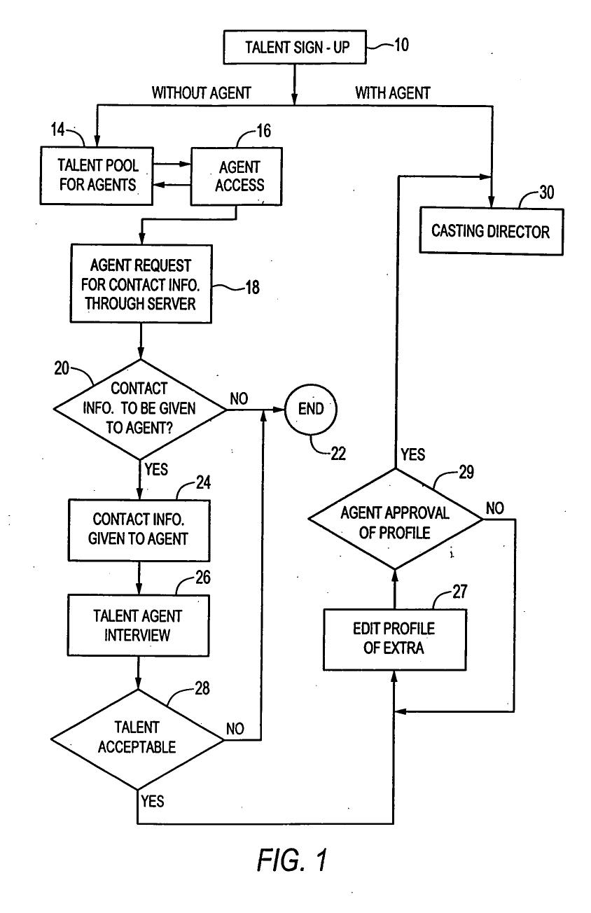

Referring to FIG. 1, as a preliminary step each performer or extra at step 10 is required to sign up inputting to the database information such as his/her name, contact information, agent information, union status, experience, special skills and measurements.

There is also an additional section for child performers, if they are recorded in the database.

The profile also includes a photograph of the performer, supplied by either the performer or the agent. Additional special features, such as streaming or stored video/audio clips or pictures of performances/skills, can also be included in the profile.

Preferably, the performer enters all the necessary information themselves through blank forms on a computer. Alternatively, the information can be supplied or input from an agent. Only the performer, the performer's agent or administration can access the profile to update or change it as required.

Once signed up, the extra is listed on a talent pool for Agents at step 14. At step 16 agents are able to access this talent pool listing and then, at step 18, request contact information for any extras deemed of interest through a server. If the agent is approved to receive this information at step 20, then the contact information is provided at step 24. Otherwise the process is ended for that extra at step 22. After the contact information is given to the agent, the agent conducts an interview at step 26 and at step 28 it is determined whether or not that extra is acceptable to the agent. If not the process is ended. Otherwise the extra has the opportunity at step 27 to edit his/her profile after which the agent reviews the change and at step 29 determines whether or not it is acceptable. If not the method returns to step 27 where the extra corrects his/her profile in accordance with the agent's requirements. If the change is acceptable, then the system goes to the casting director at step 30. The agent can also edit the profile of the extra.

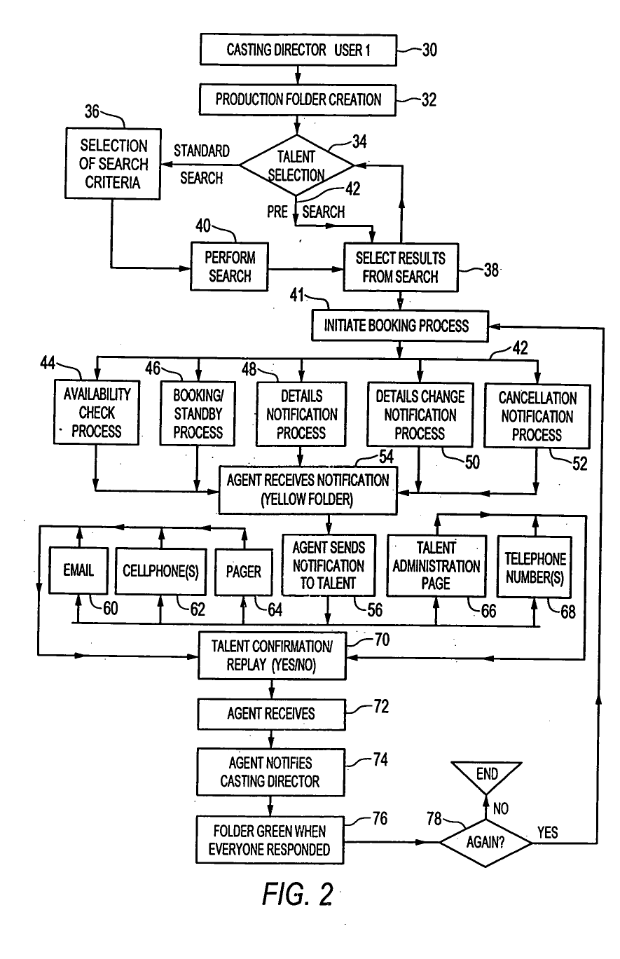

The third user category is the casting director or director category. Referring to FIG. 2, at step 30, the casting director creates a production folder 32 by naming the production, the scenes and inputting dates. The system automatically assigns the correct color from the colors yellow, green, red and black to the folder. Yellow signifies that processing is ongoing; green indicates that the process is done, while red indicates the need for attention and black indicates the meter is archived. The casting director can sign on to the database and download the content to conduct a search of the profiles to fulfill casting needs for a production. At step 34 the casting director can either conduct a pre-search of the database at step 42 to restrict the number of profiles or conduct a thorough search by first selecting the search criterion at step 36 and then at step 40 uses those criterion in performing a search. In both searches, the results are selected at step 30. At step 41, the booking process is initiated resulting in a number of concurrent steps. At step 44 availability of the extra is checked. At step 46 the extra is either booked or placed on a standby list. At step 48 the server initiates a notification of the extra while at step 50 any change to the details of the notification is determined. At step 52 whether or not the notification process is to be cancelled is determined. At step 54, the results from steps 44, 46, 48, 50, and 52 are all processed and, based on the information in the latter steps, appropriate notification to the agent is given. At step 56 the server on behalf of the agent sends notification of the extra either by email at step 60, by cellphone at step 62, by pager at step 64, by telephone at step 68, or through an administrator at step 66. At step 70, the extra provides a confirmation/reply, which the agent receives at step 72, and at step 74 the agent notifies the casting director. Once everyone responds, the color of the folder is changed to green to correspond with a process that is complete. At step 78 it is determined whether or not the process is to be repeated for another extra. If it is, then the system returns to step 40 to once again initiate the booking process. If not, then the process is ended.

The casting director is also provided with contact information from the profile in order to contact the agents of the performers and subsequently the performers to present them with the terms of employment. There is also a separate contact form to allow casting directors to report out-of-date or incorrect profiles to agents and/or administrators, if desired.

The last category is the administrator. Administrators have full access to all areas of the database, including access IDs and passwords for all other categories of user. The administrator access allows for maintenance and control of the core database system.

The database system is preferably designed as a website-based application.

The casting director is provided with a portable computer from the database operators. Depending on memory and speed requirements, the portable computer can be of any type, from a full-fledged laptop computer, a personal digital assistant, or a tablet computer. The casting director then connects to the database using an Internet connection or the database may be pre-stored on the portable computer.

Once connected, the casting director queries the database with the requirements for the desired extras. The database then generates a set of results that match the query and all the relevant profiles are downloaded to the portable computer, allowing the casting director to peruse them at leisure while being disconnected from the database.

Alternatively, the casting director can request a download of the entire content of a certain section of the database (e.g. all males between 30 and 45) and then perform a more sophisticated search to narrow down the number of profiles on the portable computer.

Once the casting director has selected the desired extras from the profiles, they then reconnect to the system and transmit a message listing all of the desired extras along with the necessary information required to ensure their attendance (e.g. time and place). The system then contacts each extra using the contact information in their profile. Contact is typically made by phone using an automated calling system, however, email, text messaging or other means can be used, depending on the capabilities of the system and preference listed in the extra's profile.

As casting directors typically travel from location to location with production crews, the casting director requires information on extras for the local area of the production. Therefore, by having the database service provide a portable computer to the casting director as needed, the casting director is assured of only having relevant profiles on the computer. Additionally, the portable computer can come pre-loaded with some or all of the database content, eliminating the need to access the database initially, other than for updating purposes and transmitting information.

The database can additionally provide banking and payments services for casting directors, performers and agents. The production or payroll company can set up an account associated with their database access ID that can be used to pay performers after job completion.

Each performer, in their profile, provides banking information, which is securely held in the database or behind a firewall on the agent's computer. This information remains confidential and is not accessible to the casting directors or administrator and is not part of the profiles downloaded by the casting director. The banking information should also include the specifics of the amount due to the performers agent after a successful job. The agents should also provide similar secure banking information with their profile. Automatic year-end tax calculations and information as to what is tax deductible is provided on a per production basis.

After job completion, production transfers funds from payroll into their database account to cover payment for the extras. A message is sent to the database listing the extras and how much each is to be paid from the funds. The database then forwards the funds directly to the performer's bank account and sends a confirmation message (similar to the automated contact message system described above) notifying the performer that the funds are available. The system simultaneously deducts the necessary agent's commission from the funds due to the performer and forwards this amount directly to the agent, with a similar notification to the agent that funds have been transferred. Production or payroll is then provided with a confirmation that all funds were successfully transferred or notified of any funds that were not and the reason why they were not successfully transferred.

The automated payment system can also deduct the necessary taxes, benefits, union dues or other deductions if the necessary information is provided in the profile. If such deductions take place, the system should also be able to generate a summary for the performer to satisfy any tax or other government requirements.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention.

I claim:

1. A method of listing selecting, contacting and hiring extras for film or television, comprising:
(a) providing a web accessible server with a database containing profiles for extras;
(b) providing a computerized sign-up for extras both for those that are represented by an agent and for those that are not;
(c) providing agent access to a listing of extras that are not represented by an agent through said server;
(d) recording information on extras accepted for representation by an agent on said database;
(e) providing database information to a casting director;
(f) searching said database for extras fitting a profile specified by said casting director; and
(g) determining availability of each extra located in step (f) and then notifying by said server those of said extras that are available.

2. The method of claim 1, including, after step (f), booking and placing available extras on standby lists.

3. The method of claim 1, including, after step (f), notifying agents of selected extras who are clients of said agent.

4. The method of claim 1, including; after step (f), entering a change to a process of notifying said agent of selected extras who are clients of said agent.

5. The method of claim 1, including, after step (f), entering a cancellation of a process of notifying agents of selected extras who are clients of said agents.

6. The method of claim 1, including providing said casting director with a computer having said database stored on memory thereof.

7. The method of claim 1, wherein step (g) includes
(a) booking each selected available extra;
(b) placing on standby each available extra not selected in step (a);
(c) notifying by server each extra in (a) and (b) of their booking status;
(d) forwarding to agent confirmation from each selected extra of acceptance of booking;
(e) communicating to casting director acceptance of booking by each selected extra; and
(f) repeating steps (a) to (e) until all positions have been booked or until there are no more available extras.

8. The method of claim 1, including providing an account associated with an access ID of said database that can be used to pay extras after job completion.

9. The method of claim 8, wherein said server pays agents' commission, extras and determines any taxes, dues and other deductions.
